(19) United States
(12) Patent Application Publication
(10) Pub. No.: US 2024/0230202 A9
(43) Pub. Date: Jul. 11, 2024

(54) SILICON THERMALIZER FOR CRYOGENIC MICROWAVE APPLICATION USING A COPLANAR WAVE GUIDE STRUCTURE

(71) Applicant: International Business Machines Corporation, Armonk, NY (US)

(72) Inventors: David Abraham, Croton, NY (US); Gerard McVicker, Stormville, NY (US); Sri M. Sri-Jayantha, Ossining, NY (US); Vijayeshwar Das Khanna, Milwood, NY (US); Nicholas A. Masluk, Putnam, NY (US)

(21) Appl. No.: 17/445,265

(22) Filed: Aug. 17, 2021

(51) Int. Cl. F25D 3/10; H01P 3/00

(52) U.S. Cl. CPC F25D 3/10; H01P 3/003

(57) ABSTRACT

A cryogenic system comprising a first cryogenic stage and a second cryogenic stage. A first signal line passing from the first cryogenic stage and is connected to a superconducting thermal break in the second cryogenic stage. A second signal line connecting the superconducting thermal break to a cryogenic device.

### STATEMENT REGARDING FEDERALLY FUNDED RESEARCH AND DEVELOPMENT

This invention was made with U.S. Government support. The U.S. Government has certain rights in this invention.

### BACKGROUND

The present invention relates generally to the field of microwave signal transmission into a cryogenic system, and more particularly preventing the heat from the signal line to be transmitted to a cryogenic device.

Heat management is an important issue within any type of cryogenic system. Design factors such as heat reduction, heat removal, heat generation, and location of any heat sink are considerations for a cryogenic system. Some devices within a cryogenic system can be sensitive to heat, which can cause errors in how some devices operate.

### BRIEF SUMMARY

Additional aspects and/or advantages will be set forth in part in the description which follows and, in part, will be apparent from the description, or may be learned by practice of the invention.

A cryogenic system comprising a first cryogenic stage and a second cryogenic stage. A first signal line passing from the first cryogenic stage and is connected to a superconducting thermal break in the second cryogenic stage. A second signal line connecting the superconducting thermal break to a cryogenic device.

The superconducting thermal break prevents the transfer of heat from first signal line to second signal line.

The superconducting thermal break is a superconducting coplanar wave guide or a superconducting transmission line. The coplanar wave guide is comprised of a substrate, an input, a superconducting metal layer, and an output.

A material of the superconducting metal layer comprises a material selected from a group consisting of: aluminum, gallium, indium, lanthanum, molybdenum, niobium, rhenium, ruthenium, tin, tantalum, titanium, zinc, zirconium, and alloys thereof.

The superconducting coplanar wave guide has an impedance that matches the impedance of the first signal line and the second signal line.

The superconducting metal layer has a width of 10 μm, a 6 μm gap exist between the superconducting metal layer and the ground plane.

The superconducting coplanar wave guide has a length greater than or equal to 2 mm. The superconducting coplanar wave guide has a length greater than or equal to 4 mm. The superconducting coplanar wave guide has a length greater than or equal to 6 mm. The superconducting coplanar wave guide has a length greater than or equal to 10 mm.

The coplanar wave guide is mounted to a bracket, wherein the superconducting coplanar wave guide transfers heat from first signal line to the bracket instead of transferring the heat to the second signal line. The bracket is comprised of copper or a suitable heat conductor.

A cryogenic system comprising a first cryogenic stage and a second cryogenic stage. A first signal line passing from the first cryogenic stage and is connected to an attenuator. A second signal line connected to an output of the attenuator and connected to a superconducting thermal break in the second cryogenic stage. A third signal line connecting the superconducting thermal break to a cryogenic device.

The superconducting thermal break prevents the transfer of heat from first signal line to second signal line.

The superconducting thermal break is a superconducting coplanar wave guide or a superconducting transmission line. The coplanar wave guide is comprised of a substrate, an input, a superconducting metal layer, and an output.

A material of the superconducting metal layer comprises a material selected from a group consisting of: aluminum, gallium, indium, lanthanum, molybdenum, niobium, rhenium, ruthenium, tin, tantalum, titanium, zinc, zirconium, and alloys thereof.

The superconducting coplanar wave guide has an impedance that matches the impedance of the first signal line and the second signal line.

The superconducting metal layer has a width of 10 μm, a 6 μm gap exist between the superconducting metal layer and the ground plane.

The superconducting coplanar wave guide has a length greater than or equal to 2 mm. The superconducting coplanar wave guide has a length greater than or equal to 4 mm. The superconducting coplanar wave guide has a length greater than or equal to 6 mm. The superconducting coplanar wave guide has a length greater than or equal to 10 mm.

The coplanar wave guide is mounted to a bracket, wherein the superconducting coplanar wave guide transfers heat from first signal line to the bracket instead of transferring the heat to the second signal line. The bracket is comprised of copper or a suitable heat conductor.

A cryogenic system comprising a first cryogenic stage, a second cryogenic stage and a third cryogenic stage. A first signal line passing from the first cryogenic stages and is connected to a superconducting thermal break in the second cryogenic stage. A second signal line connecting the superconducting thermal break to the third cryogenic stage.

The superconducting thermal break prevents the transfer of heat from first signal line to second signal line.

The superconducting thermal break is a superconducting coplanar wave guide or a superconducting transmission line. The coplanar wave guide is comprised of a substrate, an input, a superconducting metal layer, and an output.

A material of the superconducting metal layer comprises a material selected from a group consisting of: aluminum, gallium, indium, lanthanum, molybdenum, niobium, rhenium, ruthenium, tin, tantalum, titanium, zinc, zirconium, and alloys thereof.

The superconducting coplanar wave guide has an impedance that matches the impedance of the first signal line and the second signal line.

The superconducting metal layer has a width of 10 μm, a 6 μm gap exist between the superconducting metal layer and the ground plane.

The superconducting coplanar wave guide has a length greater than or equal to 2 mm. The superconducting coplanar wave guide has a length greater than or equal to 4 mm. The superconducting coplanar wave guide has a length greater than or equal to 6 mm. The superconducting coplanar wave guide has a length greater than or equal to 10 mm.

The coplanar wave guide is mounted to a bracket, wherein the superconducting coplanar wave guide transfers heat from first signal line to the bracket instead of transferring the heat to the second signal line. The bracket is comprised of copper or a suitable heat conductor.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a cryogenic system illustrating a signal line passing through a plurality of cryogenic stages to reach a cryogenic device.

FIG. 2 illustrates a flow chart for the microwave signal transmission path through the final stage of the cryogenic system, in accordance with an embodiment of the present invention.

FIG. 3 illustrates a cryogenic stage that includes a superconducting thermal break connected to the signal line and the cryogenic device, in accordance with an embodiment of the present invention.

FIG. 4 illustrates isothermal lines on the coplanar wave guide superconducting thermal break, in accordance with an embodiment of the present invention.

FIG. 5 illustrates top view of a coplanar wave guide superconducting thermal break, in accordance with an embodiment of the present invention.

FIG. 6 illustrates a cross section of the coplanar wave guide superconducting thermal break along dashed line A-A, in accordance with an embodiment of the present invention.

FIG. 7 is a graph illustrating that the distance of the input pin to output pin on the coplanar wave guide superconducting thermal break affects how effective the coplanar wave guide acts as a superconducting thermal break, in accordance with an embodiment of the present invention.

FIG. 8 is a graph comparing a cryogenic system having a superconducting thermal break and a cryogenic system not having a thermal break, in accordance with an embodiment of the present invention.

FIG. 9 illustrates a cryogenic system that includes a superconducting thermal break connected to the signal line between two cryogenic stages, in accordance with an embodiment of the present invention.

FIGS. 10A and 10B are graphs comparing a cryogenic system having a superconducting thermal break and a cryogenic system having a non-superconducting thermal break, in accordance with an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying”, “atop”, “on top”, “positioned on” or “positioned atop” mean that a first element, such as a first structure, is present on a second element, such as a second structure, wherein intervening elements, such as an interface structure may be present between the first element and the second element. The term “direct contact” means that a first element, such as a first structure, and a second element, such as a second structure, are connected without any intermediary conducting, insulating or semiconductor layers at the interface of the two elements.

In the interest of not obscuring the presentation of embodiments of the present invention, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is rather focused on the distinctive features or elements of various embodiments of the present invention.

Various embodiments of the present invention are described herein with reference to the related drawings. Alternative embodiments can be devised without departing from the scope of this invention. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” can be understood to include any integer number greater than or equal to one, i.e. one, two, three, four, etc. The terms “a plurality” can be understood to include any integer number greater than or equal to two, i.e. two, three, four, five, etc. The term “connection” can include both an indirect “connection” and a direct “connection.”

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. The terms “about” or “substantially” are intended to include the degree of error associated with measurement of the particular quantity based upon the equipment available at the time of filing application. For example, “about” can include a range of ±8% or 5%, or 2% of a given value. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value. The terms “about” or “substantially” are intended to include the degree of error associated with measurement of the particular quantity based upon the equipment available at the time of filing application.

Reference will now be made in detail to the embodiments of the present invention, examples of which are illustrated in the accompanying drawings, wherein like reference numerals refer to like elements throughout. Embodiments of the invention are generally directed to a cryogenic system, having a signal line with bandwidth up to and optionally including the microwave region. The signal line may pass through at least one cryogenic cooling stage and contain a superconducting thermal break in the signal line prior to the signal line reaching the cryogenic device. The signal line can be any type of signal line that will function at cryogenic temperature, for example, a coaxial cable having a 50 ohm impedance. In such a system the superconducting thermal break should match the impedance of the signal line to reduce, for example, signal reflection when relevant signals are in the RF or microwave domain. A drive signal generator generates a signal, for example, a microwave signal, to be transmitted to a cryogenic device within the cryogenic system via the signal line. The drive signal generator can further generate heat that will be transmitted through the conductor of the signal line. The signal line transmits a signal that has an electrical signal component, furthermore the signal line transmits thermal energy from higher temperature stages and heat that has been generated in the system. The signal is transmitted through at least one cold attenuator. The attenuator reduces the noises amplitude along with the amplitude of the desired signal, however, the attenuator also generates heat that will be transmitted through the conductor of the signal line. The signal is at a target amplitude when leaving the attenuator, where the targeted amplitude is based on the signal power and the attenuation (and modifying the attenuators allows manipulation of the signal amplitude). The signal can be transmitted through an attenuator as it passes through each cryogenic stage.

A superconducting thermal break is attached to the signal line upstream of the cryogenic device. The superconducting thermal break should have the same impedance as the signal line so the electrical signal component can be transmitted without causing signal reflection. The present invention utilizes the poor thermal conductivity of the superconductor to substantially reduce heat flow to lower temperature stages. The superconductor restricts the heat from traveling downstream, and directs the heat towards a heat sink to remove the heat from the system.

The performance of some devices in cryogenic conditions are highly sensitive to thermal excitations. Externally generated thermal disturbance could be inadvertently transferred to the cryogenic device through input/output lines or by direct radiation. In certain applications microwave signals are delivered to cryogenic devices maintained at temperatures in the milliKelvin (mK) range.

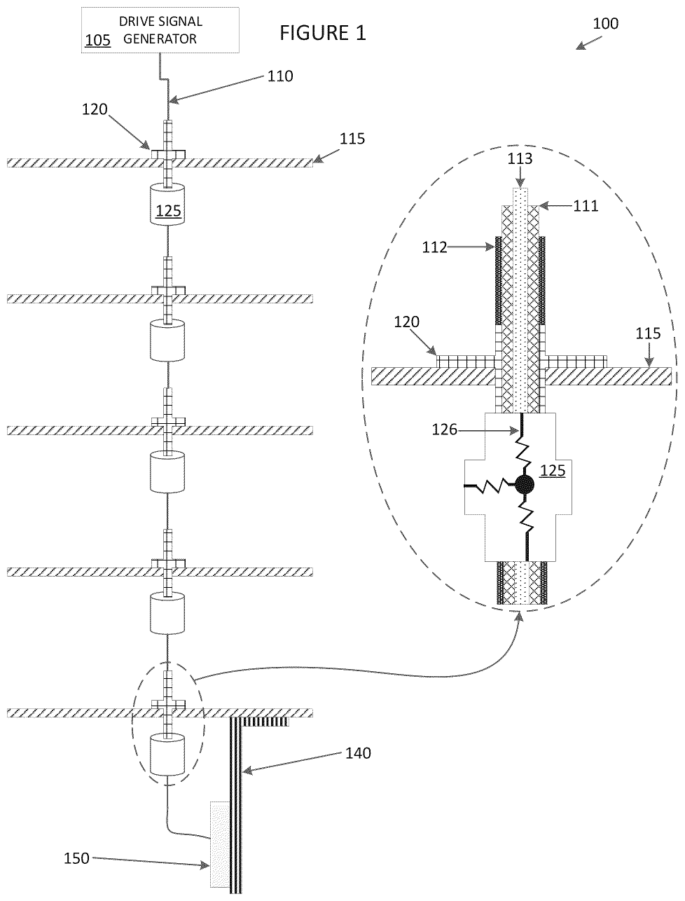

FIG. 1 illustrates a cryogenic system 100 having a signal line 110 that passes through a plurality of cooling stages 115 before reaching a cryogenic device 150. The cryogenic system 100 includes a drive signal generator 105, a signal line 110, a plurality of feed-through units 120, a plurality of attenuators 125, a plurality of cryogenic stages 115, a cryogenic device 150, and a bracket 140. The drive signal generator 105 generates a signal, for example, a microwave, to be transmitted to the cryogenic device 150 within the system. The magnified section of the FIG. 1 provides a more detailed view of the components at one of the feed through units 120. The signal line 110 includes a conductor 113, a dielectric material 111, and a ground shield 112. The dielectric material 111 that separates the conductor 113 and grounded shield material 112 helps to achieve desired electrical impedance. The signal line 110 is connected to the attenuator 125 with an output line being connected to another cryogenic stage or to the cryogenic device 150. The conductor 113 in the signal line 110 is connected to a conducting element 126 within the attenuator 125, and the conducting element 126 is connected to the conductor 113 in the output signal line 110. So any thermal energy generated by a previous device (the drive signal generator 105, or upstream attenuator 125) flows downstream through the conductor 113. The temperature of the conducting element 126 at the output of the attenuator 125 is ideally intended to be at the same temperature as the cryogenic stage 115. However, using the configuration of FIG. 1, this does not occur. The temperature of the conductor element 126 tends to be higher than the cryogenic stage 115 temperature because the thermal energy generated by a previous device (the drive signal generator 105, or upstream attenuator 125) will cause the temperature of the conducting element 126 to rise. Power dissipation in the attenuator may additionally contribute to an increase in the center conductor temperature. Such temperature increases may have impacts on downstream devices operating at lower cryogenic stages. Therefore, the conducting element 126 in the attenuator 125 output connected to the conductor 113 of the output signal line 110 is not cooled sufficiently.

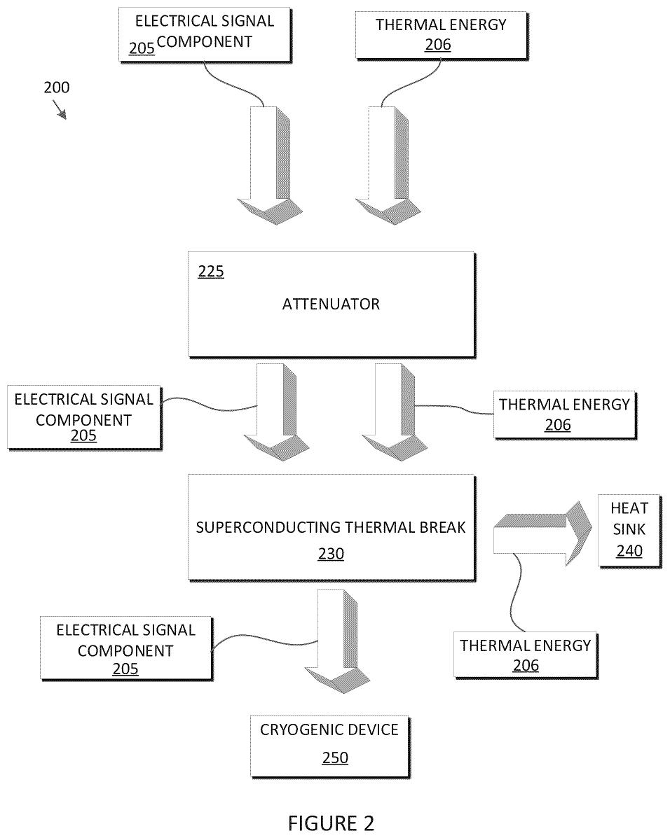

FIG. 2 illustrates a flow chart for a microwave signal transmission path through the final stage of the cryogenic system 200, in accordance with an embodiment of the present invention.

Thermal energy 206 is generated within a cryogenic system 200, where the thermal energy 206 can be generated by a signal source (not shown) and/or an upstream attenuator (not shown). The conductor of the signal line transmits the electrical signal component downstream but can also conduct any thermal energy 206 downstream. As discussed above, the conductor of the signal line is wrapped in a dielectric material so the transmitted thermal energy 206 cannot be dissipated to the surrounding environment. FIG. 2 is a flow chart illustrating the final stage of the cryogenic system 200. The signal line transmits the electrical signal component 205 and thermal energy 206 from a proceeding cryogenic stage (not shown). The signal line can be connected to an attenuator 225, when necessary, and the attenuator 225 can reduce the amplitudes of the incoming electrical signal components 205. However, the attenuator 225 can further generate additional thermal energy 206 that can be transmitted downstream by the signal line. A signal line connects the output of the attenuator 225 to an input to a superconducting thermal break 230. The superconducting thermal break 230 transmits the electrical signal component 205 to an output that is connected to the cryogenic device 250. The thermal energy 206 that is conducted to the superconducting thermal break 230, is constrained/reduced in flowing to the cryogenic device 250. The superconducting thermal break 230 includes a superconducting metal having poor thermal conductivity. The poor thermal conductance of the superconducting metal causes the thermal energy 206 to be dissipated into a substrate (which the superconducting metal is mounted on) and/or into a heat sink 240. The thermal energy 206 is dissipated into the substrate and/or the heat sink 240 since it is the path of least resistance for thermal energy 206.

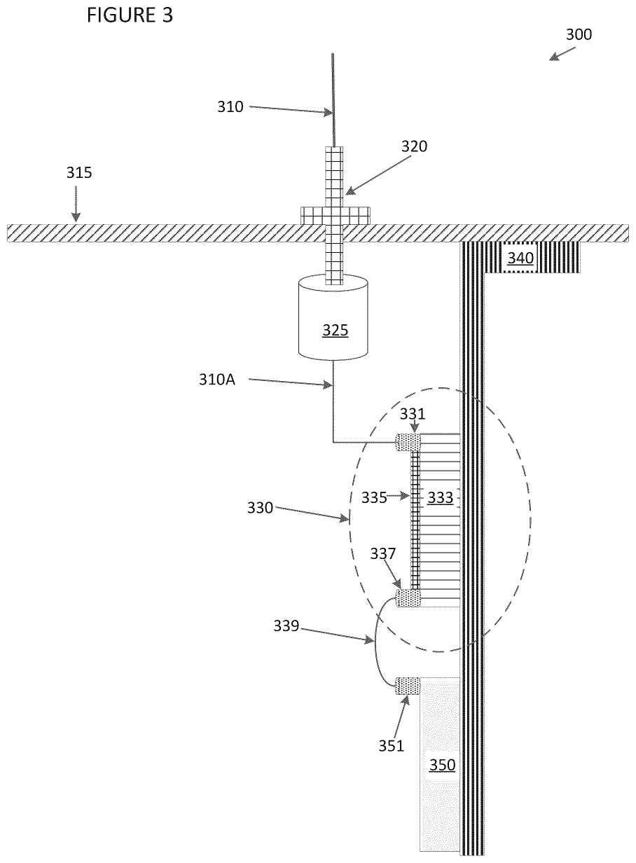

FIG. 3 illustrates a cryogenic stage 315 that includes a superconducting thermal break 330 connected to output 310A and connected to the cryogenic device 350, in accordance with an embodiment of the present invention.

The cryogenic system 300 includes a signal line 310 from a preceding cryogenic stage (not shown), wherein the signal line 310 enters a feed through 320 that allows the signal line 310 to pass through cryogenic stage 315 and into an attenuator 325. The signal line 310, 310A, and 339 include a conductor, a dielectric material and a shield material. The dielectric material that separates the signal line 310, 310A, 339 and grounded shield material help achieve desired electrical impedance. However, any thermal energy 206 that was generated upstream from an upstream driver, an upstream device, and/or an upstream attenuator is conducted downstream through the signal line 310, 310A, since the dielectric material prevents a substantial amount of the thermal energy 206 from dissipating. The signal line 310, 310A, and 339 can be, for example, coaxial cables. However, the signal line 310, 310A, and 339 can be any type of cable or signal transmission means that have an impedance that can be matched by the superconducting thermal break 330 and any type of cable or signal transmission means will operate at cryogenic temperatures.

An attenuator 325 can be used at each cooling stage 315 to progressively reduce amplitudes of the signal being transmitted in the signal line 310. The attenuator 325 includes a conducting element (not shown) as described above, that is connected to the conductor of the incoming signal line 310 and connected to the conductor of the output signal line 310A. The operating temperature of the conducting element at the output of the attenuator 325 is intended to be at the temperature of the cryogenic stage 315 where the cryogenic device 350 is located. However, this does not occur. The temperature of the conductor element at the output of the attenuator 325 tends to be higher than the cryogenic stage 315 temperature because the upstream temperature is greater than the cryogenic stage 315, and thermal energy is generated by a previous device (the drive signal generator (not show), or upstream attenuator (not shown)) or the attenuator 325.

The cryogenic stage 315 has a temperature in the milliKelvin (mK) range, for example, the temperature can be around 10 mK. This temperature is not meant to be seen as limiting, as the temperature of the cryogenic stage 315 can be operated at any temperature needed for the cryogenic device 350. The temperature of the stage also directly affects the material choice of the superconducting thermal break 330. The metal selected to be used in the superconducting thermal break 330 can be a superconductor metal at the temperature of the cryogenic stage 315. The cryogenic device 350 can be selected from a group comprised of an electronic device, a chip, a transmission line, an interposer, a sensor, a resonator, or another type of device the receives a signal from the signal line 339.

The first output signal line 310A from the attenuator 325 is connected to an input connector 331 of the superconducting thermal break 330. Alternatively, the first output signal line 310A can be directly connected to an input on the superconducting thermal break 330. The superconducting thermal break 330 is mounted to a bracket 340. The superconducting thermal break 330 includes an input connector 331, a substrate 333, a superconducting transmission line 335, an output connector 337, and a second output line 339 connected to an input connector 351 on the cryogenic device 350. Alternatively, the first output signal line 310A and the second output signal line 339 can be wirebonded directly to the superconducting thermal break 330. The superconducting thermal break 330 has the same impedance as the first output signal line 310A. The superconducting thermal break 330 receives the signal at the input connector 331, wherein the signal contains an electrical signal component 205. The superconducting thermal break 330 further receives thermal energy 206 being conducted downstream by the first output signal line 310A. The superconducting thermal break 330 transmits the electrical signal component 205 to the output connector 337 via the superconducting transmission line 335, but superconducting transmission line 335 restricts the thermal energy 206 from flowing downstream. The superconducting transmission line 335 has poor thermal conducting properties, thus the superconducting transmission line 335 reduces the thermal energy 206 flowing downstream. The poor thermal conducting properties of the superconducting transmission line 335, causes the thermal energy 206 to be dissipated into a substrate 333 (which the superconducting transmission line 335 is mounted on) and/or into a heat sink 340. The thermal energy 206 is dissipated into the substrate 333 and/or the heat sink 340 since it is the path of least resistance for thermal energy 206. The bracket 340 can be comprised of any type thermally conductive material such as, for example, copper or another suitable heat conductor. The dissipated heat from the superconducting thermal break 330 is shunted to the cryogenic stage 315 via the bracket 340. The superconducting thermal break 330, can be, for example, a coplanar wave guide, or a superconducting transmission line, however, the superconducting thermal break 330 can be any type of superconducting transmission component. The key factor is that the transmission component 335 needs to be a superconductor so that the electrical signal component 205 will be transmitted to the output connector 337, while the thermal energy component 206 is prevented from being conducted to the output connector 337.

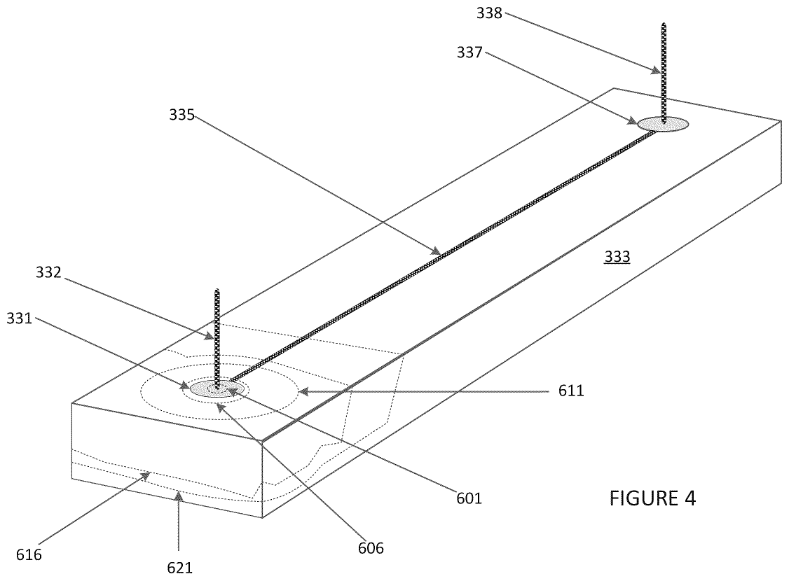

FIG. 4 illustrates isothermal lines on the coplanar wave guide superconducting thermal break 330, in accordance with an embodiment of the present invention.

The coplanar wave guide superconducting thermal break 330 includes an input connector 331, an input pin 332, a superconducting transmission line 335, an output connector 337, an output pin 338, and a substrate 333. Dashed lines 601, 606, 611, 616, 621 represent the isothermal lines of depicting a temperature gradient along the substrate 330. The isothermal line 601 represents the hottest area in close proximity to the input pin 332, while isothermal line 621 represents the coolest area. The area of the substrate 333, outside the coolest isothermal line 621 area, is not substantially affected by the thermal energy 206 and is at, or substantially near to, the temperature of cryogenic stage 315. The incoming thermal energy 206 dissipates into the substrate 333 surrounding the input connector 331 and shunted to the bracket 340 (see FIG. 3). The thermal energy component 206 is not transmitted to the output connector 337 or the output pin 338. Therefore, the output connector 337 and the output pin 338 are at the same temperature as the temperature of cryogenic stage 315. Thus, only thermal energy from upstream of the thermal break is not transmitted to the cryogenic device 350.

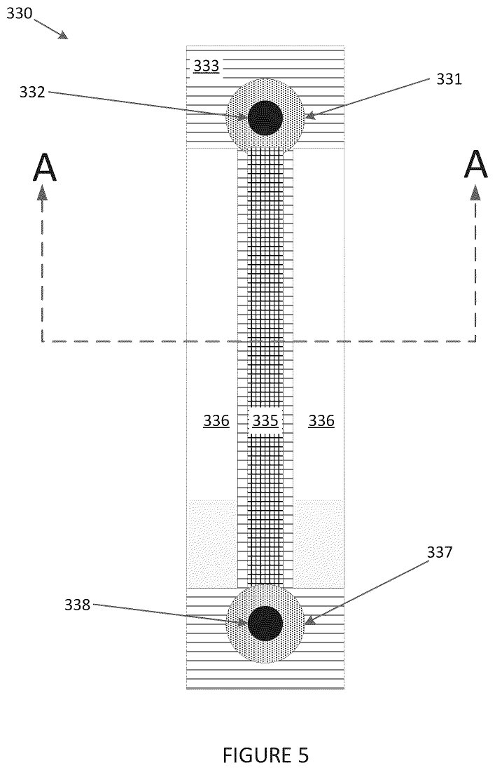

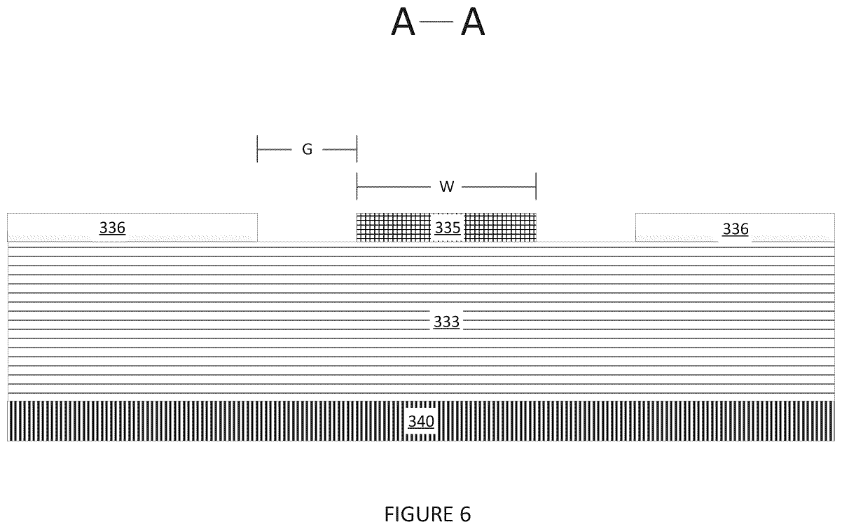

FIG. 5 illustrates a top view of a coplanar wave guide superconducting thermal break 330, in accordance with an embodiment of the present invention. FIG. 6 illustrates a cross section of the coplanar wave guide superconducting thermal break 330 along dashed line A-A, in accordance with an embodiment of the present invention.

The coplanar wave guide superconducting thermal break 330 includes an input connector 331, an input pin 332, a superconducting transmission line 335, an output connector 337, an output pin 338, ground planes 336, and a substrate 333. The superconducting transmission line 335 is a metal that has superconducting properties at the temperature of cryogenic stage 315. Therefore, if the temperature is set at 10 mK for the cryogenic stage, then the superconducting transmission line 335 can be comprised of, for example, niobium. The superconducting metal can be aluminum, gallium, indium, lanthanum, molybdenum, niobium, rhenium, ruthenium, tin, tantalum, titanium, zinc, zirconium, alloys thereof, and the like. The superconducting transmission line 335 is formed on top of substrate 333. The substrate 333, can be, for example, a silicon wafer, single crystal quartz, a SiGe wafer, a II-IV material, a III-V material, or any type of suitable material to act as a substrate for fabrication of superconducting coplanar wave guides.

FIG. 6 illustrates a cross section of the coplanar wave guide superconducting thermal break 330 along dashed line A-A, illustrating that the width of the superconducting transmission line 335 can be, for example, 10 μm. The gap between the superconducting transmission line 335 and the ground plane 336 can be, for example, 6 μm. The thickness of the superconducting transmission line 335 and the ground plane 336 are in the range of 0.1 to 10 μm. The superconducting transmission line 335 can be a niobium film that is formed on a silicon substrate 333. The coplanar wave guide superconducting thermal break 330 can have, for example, a 50 ohm impedance, which matches the impedance of the first output signal line 310A and the second output signal line 339. The length of the coplanar wave guide superconducting thermal break 330, i.e. the distance between the input pin 332 and the output pin 338, should be greater than 2 mm. The dimensions for the coplanar wave guide superconducting thermal break 330 are meant to be for example purposes only. The dimensions of the coplanar wave guide superconducting thermal break 330 determine the impedance of the device, thus the dimension can be altered to match the impedance of the signal lines 310, 310A, and 339. The incoming thermal energy 206 that was conducted through the first output signal line 310A to the superconducting thermal break 330 is dissipated through the substrate 333 to the bracket 340 and shunted to the cryogenic stage 315. The bracket 340 can be comprised of any type of thermally conductive material, for example, copper.

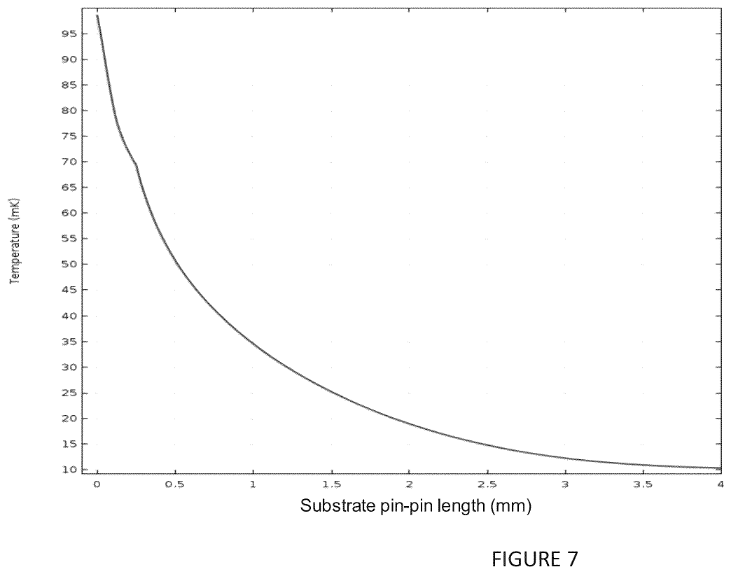

FIG. 7 is a graph illustrating that the input pin 332 to output pin 338 length of the coplanar wave guide superconducting thermal break 330 affects the effectiveness the coplanar wave guide acting as a superconducting thermal break 330, in accordance with an embodiment of the present invention. The y-axis of the graph illustrates the temperature at the output pin 338 and the x-axis represent the distance between the input pin 332 to output pin 338. This graph indicates that distance between the input pin 332 to output pin 338 does affect the temperature at the output pin 338. The graph illustrates that as the length between pins 332 and 338 increases than the temperature at the output pin 338 decreases.

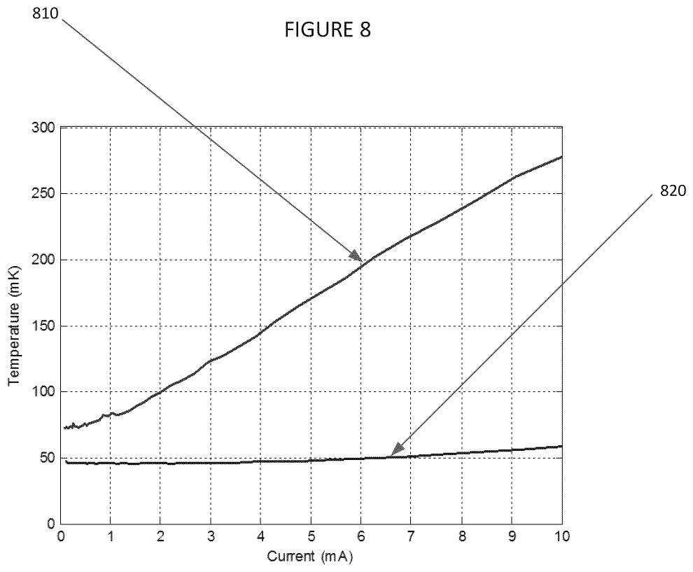

FIG. 8 is a graph comparing a cryogenic system having a superconducting thermal break 330 and a cryogenic system not having a thermal break, in accordance with an embodiment of the present invention.

FIG. 8 is a graph illustrating the effectiveness of the present invention, where the x-axis represents a current drive to the input of the system which results in heating of attenuators preceding the invention. Line 810 represent a conventional cryogenic system that does not have a superconducting thermal break. Line 820 represents a cryogenic system that contains a superconducting thermal break 330 in accordance with the present invention. The superconducting thermal break 330 used in the cryogenic system 300 of line 820 includes a coplanar wave guide having a silicon substrate 333 with an 8 mm long niobium superconducting transmission line 325. Line 810 as illustrated by the graph has an increasing output temperature as the current increase at as significant linear rate. Line 820 representing the present invention, clearly illustrate by the graph, shows that as the current increases then the output temperature remains flat with having only minor changes. Reduction in signal line temperature at the output line 339 is achieved by the coplanar wave guide superconducting thermal break 330. For example, at 10 mA drive current a peak output signal line temperature of 275 mK (line 810, i.e. a cryogenic system having no superconducting thermal break) is reduced to about 60 mK (line 820, i.e. the cryogenic system 300 that utilizes a superconducting thermal break 330).

A coplanar wave guide superconducting thermal break 330 has been shown to be effective, but it is only meant to be an exemplary structure illustrating the superconducting thermal break. However, there are variations of wave guide structures, such as a strip line, can be found where the signal line is surrounded by ground plane in different geometric forms. One structure may be more immune to ambient noise and another may provide better decoupling from neighboring signal lines.

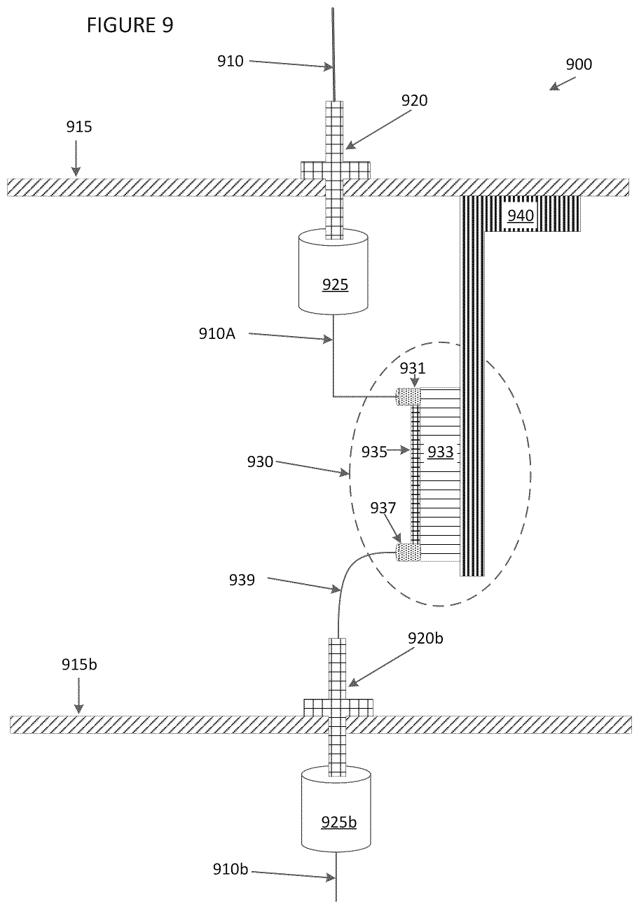

FIG. 9 illustrates a cryogenic system 900 that includes a superconducting thermal break 930 connected to the signal line between two cryogenic stages 915 and 915b, in accordance with an embodiment of the present invention.

The cryogenic system 900 includes a signal line 910 from a preceding cryogenic stage (not shown), wherein the signal line 910 enters a feed through 920 that allows the signal line 910 to pass through cryogenic stage 915 and into an attenuator 925. The signal line 910, 910A, 910b, and 939 include a conductor, a dielectric material and a shield material. The dielectric material that separates the signal line 910, 910A, 910b, and 939 and grounded shield material help achieve desired electrical impedance. However, any thermal energy 206 that was generated upstream from an upstream driver, an upstream device, and/or an upstream attenuator is conducted downstream through the signal line 910, 910A, since the dielectric material prevents a substantial amount of the thermal energy 206 from dissipating. The signal line 910, 910A, 910b, and 939 can be, for example, coaxial cables. However, the signal line 910, 910A, 910b, and 939 can be any type of cable or signal transmission means that have an impedance that can be matched by the superconducting thermal break 930 and any type of cable or signal transmission means will operate at cryogenic temperatures.

An attenuator 925 and 925b can be used at each cooling stage 915 and 915b to progressively reduce amplitudes of the signal being transmitted in the signal line 910. The attenuator 925 includes a conducting element (not shown) as described above, that is connected to the conductor of the incoming signal line 910 or 939 and connected to the conductor of the output signal line 910A or 910b. The operating temperature of the conducting element at the output of the attenuator 925 is intended to be at the temperature of the cryogenic stage 915. However, this does not occur. The temperature of the conductor element at the output of the attenuator 925 tends to be higher than the cryogenic stage 915 temperature because the upstream temperature is greater than the cryogenic stage 915, and thermal energy is generated by a previous device (the drive signal generator (not show), or upstream attenuator (not shown)) or the attenuator 925.

The cryogenic stage 915 has a temperature in the milliKelvin (mK) range, with each downstream stage, for example, cryogenic stage 915b getting progressively colder. The temperature of the stage also directly affects the material choice of the superconducting thermal break 930. The metal selected to be used in the superconducting thermal break 930 can be a superconductor metal at the temperature of the cryogenic stage 915.

The first output signal line 910A from the attenuator 925 is connected to an input connector 931 of the superconducting thermal break 930. Alternatively, the first output signal line 910A can be directly connected to an input on the superconducting thermal break 930. The superconducting thermal break 930 is mounted to a bracket 940. The superconducting thermal break 930 includes an input connector 931, a substrate 933, a superconducting transmission line 935, an output connector 937, and a second output line 939 connected to a feed through 920b that allows the signal line 939 to pass through cryogenic stage 915b and into an attenuator 925b to the output line 910b. Alternatively, the first output signal line 910A and the second output signal line 939 can be wirebonded directly to the superconducting thermal break 930. The superconducting thermal break 930 has the same impedance as the first output signal line 910A. The superconducting thermal break 930 receives the signal at the input connector 931, wherein the signal contains an electrical signal component 205. The superconducting thermal break 930 further receives thermal energy 206 being conducted downstream by the first output signal line 910A. The superconducting thermal break 930 transmits the electrical signal component 205 to the output connector 937 via the superconducting transmission line 935, but superconducting transmission line 935 restricts the thermal energy 206 from flowing downstream. The superconducting transmission line 935 has poor thermal conducting properties, thus the superconducting transmission line 935 reduces the thermal energy 206 flowing downstream. The poor thermal conducting properties of the superconducting transmission line 935, causes the thermal energy 206 to be dissipated into a substrate 933 (which the superconducting transmission line 935 is mounted on) and/or into a heat sink 940. The thermal energy 206 is dissipated into the substrate 933 and/or the heat sink 940 since it is the path of least resistance for thermal energy 206. The bracket 940 can be comprised of any type thermally conductive material such as, for example, copper or another suitable heat conductor. The dissipated heat from the superconducting thermal break 930 is shunted to the cryogenic stage 915 via the bracket 940. The superconducting thermal break 930, can be, for example, a coplanar wave guide, or a superconducting transmission line, however, the superconducting thermal break 930 can be any type of superconducting transmission component. The key factor is that the transmission component 935 needs to be a superconductor so that the electrical signal component 205 will be transmitted to the output connector 937, while the thermal energy component 206 is prevented from being conducted to the output connector 937. The thermal break 930 is the same as thermal break 330 as described above.

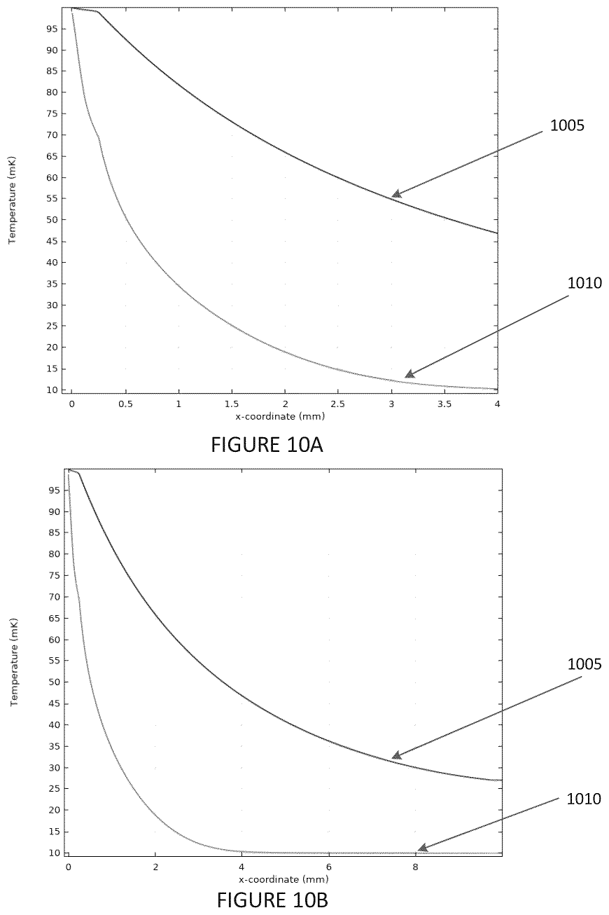

FIGS. 10A and 10B are graphs comparing a cryogenic system having a superconducting thermal break and a cryogenic system having a non-superconducting thermal break, in accordance with an embodiment of the present invention.

A non-superconducting thermal break (not shown) can be added to a cryogenic system, where the non-superconducting thermal breach has a similar design as the superconducting thermal break 330 and 930 described above. The difference is a non-superconducting metal, for example, copper, is used for the transmission line 335, 935, instead of a superconducting metal. FIGS. 10A and 10B are a graph comparing the results of a superconducting thermal break 330, 930 to a non-superconducting thermal break. The y-axis represents the temperature at the exit pin of the thermal break, for example, coplanar wave guide thermal breaks. The x-axis represents the distance (mm) between the incoming pin and the outgoing pin. Line 1005 in each of the graphs represents a non-superconducting thermal break utilizing copper as the metal for the transmission line. Line 1010 in each of the graphs represents a superconducting thermal break 330, 930 utilizing niobium as the metal for the transmission line. Line 1005 illustrates that the non-superconducting thermal break is able to reduce the temperature at the exit pin. However, the superconducting thermal break 330, 930 is able to reduce the temperature at the exit pin to a lower temperature when compared to the non-superconducting thermal break. The distance between the pins in the non-superconducting thermal break and the superconducting thermal break 330, 930 affects temperature drop along the thermal break.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A cryogenic system comprising:
a first cryogenic stage and a second cryogenic stage;
a first signal line passing from the first cryogenic stage and is connected to a superconducting thermal break in the second cryogenic stage; and
a second signal line connecting the superconducting thermal break to a cryogenic device.

2. The cryogenic system of claim 1, wherein the superconducting thermal break prevents the transfer of heat from first signal line to second signal line.

3. The cryogenic system of claim 1, wherein the superconducting thermal break is a superconducting coplanar wave guide or a superconducting transmission line.

4. The cryogenic system of claim 3, wherein the coplanar wave guide includes a superconducting metal layer.

5. The cryogenic system of claim 4, wherein a material of the superconducting metal layer comprises a material selected from a group consisting of: aluminum, gallium, indium, lanthanum, molybdenum, niobium, rhenium, ruthenium, tin, tantalum, titanium, zinc, zirconium, and alloys thereof.

6. The cryogenic system of claim 3, wherein the coplanar wave guide is comprised of:
a substrate;
an input;
a superconducting metal layer; and
an output.

7. The cryogenic system of claim 6, wherein the superconducting coplanar wave guide has an impedance that matches the impedance of the first signal line and the second signal line.

8. The cryogenic system of claim 6, wherein the superconducting metal layer has a width of 10 μm.

9. The cryogenic system of claim 8, wherein a 6 μm gap exist between the superconducting metal layer and the ground plane.

10. The cryogenic system of claim 6, wherein the superconducting coplanar wave guide has a length greater than or equal to 2 mm.

11. The cryogenic system of claim 6, wherein the superconducting coplanar wave guide has a length greater than or equal to 4 mm.

12. The cryogenic system of claim 6, wherein the superconducting coplanar wave guide has a length greater than or equal to 6 mm.

13. The cryogenic system of claim 6, wherein the superconducting coplanar wave guide has a length greater than or equal to 10 mm.

14. The cryogenic system of claim 3, wherein the coplanar wave guide is mounted to a bracket, wherein the superconducting coplanar wave guide transfers heat from first signal line to the bracket instead of transferring the heat to the second signal line.

15. The cryogenic system of claim 14, wherein the bracket is comprised of copper or a suitable heat conductor.

16. A cryogenic system comprising:
a first cryogenic stage and a second cryogenic stage;
a first signal line passing from the first cryogenic stage and is connected to an attenuator;
a second signal line connected to an output of the attenuator and connected to a superconducting thermal break in the second cryogenic stage; and
a third signal line connecting the superconducting thermal break to a cryogenic device.

17. The cryogenic system of claim 16, wherein the superconducting thermal break prevents the transfer of heat from second signal line to third signal line.

18. The cryogenic system of claim 16, wherein the superconducting thermal break is a superconducting coplanar wave guide or a superconducting transmission line.

19. The cryogenic system of claim 18, wherein the coplanar wave guide includes a superconducting metal layer.

20. The cryogenic system of claim 19, wherein a material of the superconducting metal layer comprises a material selected from a group consisting of: aluminum, gallium, indium, lanthanum, molybdenum, niobium, rhenium, ruthenium, tin, tantalum, titanium, zinc, zirconium, and alloys thereof.

21. The cryogenic system of claim 18, wherein the coplanar wave guide is comprised of:
a substrate;
an input;
a superconducting metal layer; and
an output.

22. The cryogenic system of claim 21, wherein the superconducting coplanar wave guide has an impedance that matches the impedance of the first signal line, the second signal line, and the third signal line.

23. The cryogenic system of claim 21, wherein the superconducting metal layer has a width of 10 μm.

24. The cryogenic system of claim 23, wherein a 6 μm gap exist between the superconducting metal layer and the ground plane.

25. The cryogenic system of claim 21, wherein the superconducting coplanar wave guide has a length greater than or equal to 2 mm.

26. The cryogenic system of claim 21, wherein the superconducting coplanar wave guide has a length greater than or equal to 4 mm.

27. The cryogenic system of claim 21, wherein the superconducting coplanar wave guide has a length greater than or equal to 6 mm.

28. The cryogenic system of claim 21, wherein the superconducting coplanar wave guide has a length greater than or equal to 10 mm.

29. The cryogenic system of claim 18, wherein the coplanar wave guide is mounted to a bracket, wherein the superconducting coplanar wave guide transfers heat from first signal line to the bracket instead of transferring the heat to the second signal line.

30. The cryogenic system of claim 29, wherein the bracket is comprised of copper or a suitable heat conductor.

31. A cryogenic system comprising:
a first cryogenic stage, a second cryogenic stage and a third cryogenic stage;
a first signal line passing from the first cryogenic stages and is connected to a superconducting thermal break in the second cryogenic stage; and
a second signal line connecting the superconducting thermal break to the third cryogenic stage.

32. The cryogenic system of claim 31, wherein the superconducting thermal break prevents the transfer of heat from first signal line to second signal line.

33. The cryogenic system of claim 31, wherein the superconducting thermal break is a superconducting coplanar wave guide or a superconducting transmission line.

34. The cryogenic system of claim 33, wherein the coplanar wave guide includes a superconducting metal layer.

35. The cryogenic system of claim 34, wherein a material of the superconducting metal layer comprises a material selected from a group consisting of: aluminum, gallium, indium, lanthanum, molybdenum, niobium, rhenium, ruthenium, tin, tantalum, titanium, zinc, zirconium, and alloys thereof.

36. The cryogenic system of claim 33, wherein the coplanar wave guide is comprised of:
a substrate;
an input;
a superconducting metal layer; and
an output.

37. The cryogenic system of claim 36, wherein the superconducting coplanar wave guide has an impedance that matches the impedance of the first signal line and the second signal line.

38. The cryogenic system of claim 36, wherein the superconducting metal layer has a width of 10 μm.

39. The cryogenic system of claim 38, wherein a 6 μm gap exist between the superconducting metal layer and the ground plane.

40. The cryogenic system of claim 36, wherein the superconducting coplanar wave guide has a length greater than or equal to 2 mm.

41. The cryogenic system of claim 36, wherein the superconducting coplanar wave guide has a length greater than or equal to 4 mm.

42. The cryogenic system of claim 36, wherein the superconducting coplanar wave guide has a length greater than or equal to 6 mm.

43. The cryogenic system of claim 36, wherein the superconducting coplanar wave guide has a length greater than or equal to 10 mm.

44. The cryogenic system of claim 33, wherein the coplanar wave guide is mounted to a bracket, wherein the superconducting coplanar wave guide transfers heat from first signal line to the bracket instead of transferring the heat to the second signal line.

45. The cryogenic system of claim 44, wherein the bracket is comprised of copper or a suitable heat conductor.
